(19) United States
(12) Patent Application Publication
(10) Pub. No.: US 2021/0060568 A1
(43) Pub. Date: Mar. 4, 2021

(54) VIAL HOLDER FOR COOLING TEMPERATURE REGULATION AND SAMPLE TEMPERATURE REGULATION DEVICE USING THE VIAL HOLDER FOR COOLING TEMPERATURE REGULATION

(71) Applicant: SHIMADZU CORPORATION, Kyoto (JP)

(72) Inventor: Takashi INOUE, Kyoto (JP)

(21) Appl. No.: 16/958,679

(22) PCT Filed: Aug. 22, 2018
(86) PCT No.: PCT/JP2018/031001

§ 371 Date: Jun. 27, 2020

(30) Foreign Application Priority Data
Jan. 31, 2018 (JP) 2018-014587

(51) Int. Cl. B01L 9/06; B01L 7/00

(52) U.S. Cl. CPC B01L 9/06; B01L 7/00

(57) ABSTRACT

A vial holder includes a thermally conductive holder positioned at a lower part and a non-thermally conductive holder positioned at an upper part. The thermally conductive holder is made of thermally conductive material and supports at least bottom surfaces of the vials accommodated in the accommodation holes. The non-thermally conductive holder is made of non-thermally conductive material, is arranged so as to cover an upper surface of the thermally conductive holder while being in contact with the upper surface, and includes a plurality of through holes constituting at least a part of the accommodation holes.

### TECHNICAL FIELD

The present invention relates to a sample temperature regulation device for regulating a temperature of a vial containing a liquid to a constant temperature while cooling the vial, and a vial holder for cooling temperature regulation used in the sample temperature regulation device.

### BACKGROUND ART

An automatic analysis in liquid chromatography (LC) is executed by holding a vial containing a sample in a vial holder, setting the vial holder in an autosampler, and sequentially sucking the sample using the autosampler from the vial on the vial holder according to a predetermined program, and injecting the sample into a liquid chromatograph.

The vial holder generally holds, for example, about 100 vials. In a liquid chromatograph, generally, several minutes of analysis time is required for one sample, and therefore, some samples on the vial holder may need to be in waiting for at least several hours before the analysis. The sample on the vial holder in an analysis waiting state is often kept at room temperature. However, some samples need to be kept at low temperature or at a temperature above the room temperature (for example, the same temperature as a body temperature of a person, which is 37° C.) in order to prevent deterioration of the samples. In some cases, a presence of change in a sample solution is confirmed by keeping the sample solution at a predetermined temperature for a long time. In this case, the temperature needs to be kept at a constant temperature for several tens of hours. For this reason, the autosampler is generally provided with a sample temperature regulation device for regulating the temperature of the sample in the vial held by the vial holder (for example, see Patent Document 1).

### PRIOR ART DOCUMENT

### Patent Document

Patent Document 1: U.S. Pat. No. 6,170,267

### SUMMARY OF THE INVENTION

### Problems to be Solved by the Invention

In the high-performance liquid chromatography (HPLC), cooling temperature regulation is often performed in which a temperature is regulated while a sample is cooled in a sample temperature regulation device. In such a case, a vial is often cooled through a vial holder which is mounted on a metal heat transfer member cooled by a cooling element such as a Peltier element.

The vial holder is generally made of resin such as polypropylene (PP). Because the resin such as PP has a high heat insulation effect, the vial may not be sufficiently cooled even when the vial holder is mounted on the heat transfer member of the sample temperature regulation device.

On the other hand, it is also conceivable to use a metal vial holder having good heat conductivity. However, when the metal vial holder is installed in the sample temperature regulation device and cooled, there is a problem that dew condensation water accumulates on an upper surface of the vial holder, and when the vial holder is moved, the dew condensation water spills out and the inside of the device becomes wet.

Accordingly, an object of the present invention is to make the dew condensation water not easily accumulate on the upper surface of a vial holder for cooling temperature regulation, and to sufficiently cool the vial held in the vial holder.

### Solutions to the Problems

A vial holder for cooling temperature regulation according to the present invention has a plurality of accommodation holes having openings at their tops respectively so that vials containing a liquid are inserted into the accommodation holes respectively from their bottoms via the openings, and is mounted on a heat transfer surface of the sample temperature regulation device. The vial holder includes a thermally conductive holder positioned at a lower part and a non-thermally conductive holder positioned at an upper part. The thermally conductive holder is made of thermally conductive material, and is for causing heat exchange between bottom surfaces of the vials accommodated in the accommodation holes and the heat transfer surface by supporting at least the bottom surfaces. The non-thermally conductive holder is made of non-thermally conductive material and is arranged so as to cover an upper surface of the thermally conductive holder while being in contact with the upper surface. The non-thermally conductive holder includes a plurality of through holes constituting at least a part of the accommodation holes respectively.

In the vial holder of the present invention, a side surface of the thermally conductive holder is preferably covered with a heat insulation sheet. This can prevent the dew condensation from occurring on the side surface of the thermally conductive holder.

The sample temperature regulation device according to the present invention may include a heat transfer member which is for mounting the vial holder thereon and having a hear transfer surface for transferring heat to the thermally conductive holder of the vial holder by being in contact with the thermally conductive holder, and a cooling element that cools the heat transfer member.

### Effects of the Invention

Because the vial holder of the present invention is constituted of, at the lower part, the thermally conductive holder made of thermally conductive material, when the vial holder is mounted on the heat transfer member of the sample temperature regulation device, the heat is sufficiently exchanged between the vial and the heat transfer member, and accordingly, the vial can be sufficiently cooled. Furthermore, because the upper part of the vial holder is constituted of non-thermally conductive holder, the upper surface of the vial holder, that is, the upper surface of the non-thermally conductive holder, is not easily cooled to a low temperature, and accordingly, the dew condensation water does not easily accumulate on the upper surface of the vial holder. Further, because the upper surface of the thermally conductive holder is covered with the non-thermally conductive holder, the dew condensation does not easily occur even on the upper surface of the thermally conductive holder. Therefore, the inside of the sample temperature regulation device is less likely to be wet with the dew condensation water.

The sample temperature regulation device of the present invention cools the vial using the vial holder for cooling temperature regulation. Accordingly, it is possible to sufficiently cool the vial while preventing the inside of the device from being wet with the dew condensation water on the upper surface of the vial holder.

### BRIEF DESCRIPTION OF THE DRAWINGS

FIG. 1 is a cross-sectional view showing one embodiment of a vial holder together with a sample temperature regulation device.

FIG. 2 is a cross-sectional view showing another embodiment of a vial holder.

### EMBODIMENTS OF THE INVENTION

One embodiment of a vial holder and a sample temperature regulation device are described with reference to the drawings.

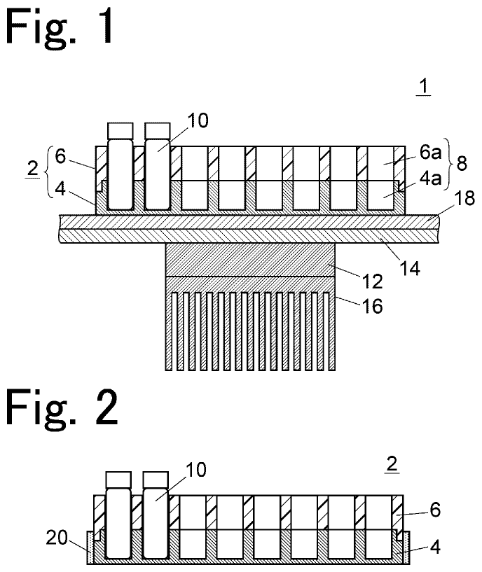

As shown in FIG. 1, a vial holder 2 is mounted on a heat transfer plate 14 (heat transfer member) of a sample temperature regulation device 1 in a state of being mounted on a sample rack 18. The sample temperature regulation device 1 is provided with at least a Peltier element 12 as a cooling element, and cools the heat transfer plate 14 by radiating the heat of the heat transfer plate 14 through heat radiation fins 16.

At least a portion of a bottom plate of the sample rack 18 on which the vial holder 2 is mounted is made of thermally conductive material such as aluminum, and therefore, it is configured that the heat is exchanged between the heat transfer plate 14 and the vial holder 2. Although not shown here, a temperature sensor is attached to the heat transfer plate 14, and an operation of the Peltier element 12 is controlled based on an output of the temperature sensor.

Although not shown in this embodiment, a heater may be attached to the heat transfer plate 14 so that a temperature of the heat transfer plate 14 can be regulated to a desired temperature by the Peltier element 12 and the heater.

The vial holder 2 includes a thermally conductive holder 4 constituting a lower part and a non-thermally conductive holder 6 constituting an upper part. The thermally conductive holder 4 is made of thermally conductive material such as aluminum. The non-thermally conductive holder 6 is made of resin material having a high heat insulation effect such as PP. A lower surface of the non-thermally conductive holder 6 is in contact with an upper surface of the thermally conductive holder 4. That is, the upper surface of the thermally conductive holder 4 is configured to be covered with the non-thermally conductive holder 6 so as not to be exposed.

The thermally conductive holder 4 has a plurality of recesses 4a on the upper surface, and the non-thermally conductive holder 6 has through holes 6a each having substantially the same inner diameter as the recess 4a at a position corresponding to each of the recesses 4a of the thermally conductive holder 4. The recess 4a of the thermally conductive holder 4 and the through hole 6a of the non-thermally conductive holder 6 constitute a housing hole 8 which is open at a top to house a vial 10.

The vial 10 housed in the housing hole 8 of the vial holder 2 is supported by at least the bottom surface of the vial 10 coming into contact with the thermally conductive holder 4. The lower surface of the thermally conductive holder 4 is in direct contact with the thermally conductive bottom plate of the sample rack 18. Because the thermally conductive holder 4 is made of material having good heat conductivity, heat exchange between the thermally conductive holder 4 and the heat transfer plate 14 is favorably performed, and the thermally conductive holder 4 is effectively cooled. Thereby, a liquid in the vial 10 whose at least the bottom surface is in contact with the thermally conductive holder 4 is effectively cooled.

On the other hand, because the non-thermally conductive holder 6 constituting the upper part of the vial holder 2 is made of resin material having a high heat insulation effect, the heat is hardly exchanged between the thermally conductive holder 4 and the non-thermally conductive holder 6. Therefore, a temperature of the upper surface of the non-thermally conductive holder 6 is hardly affected by the temperature of the cooling plate 14, and does not fall to a low temperature at which dew condensation occurs. Therefore, the dew condensation does not easily occur on the upper surface of the vial holder 2.

The thermally conductive holder 4 constituting the lower part of the vial holder 2 is cooled to a temperature at which the dew condensation can occur by the heat exchange with the cooling plate 14. However, because the upper surface of the thermally conductive holder 4 is covered with non-thermally conductive holder 6, the dew condensation does not easily occur on the upper surface of the thermally conductive holder 4.

Incidentally, in the embodiment of FIG. 1, the dew condensation may occur on a side surface of the thermally conductive holder 4. Therefore, as shown in FIG. 2, by covering the side surface of the thermally conductive holder 4 with a heat insulation sheet 20 made of, for example, polyethylene, the occurrence of the dew condensation on the side surface of the thermally conductive holder 4 can be prevented.

### DESCRIPTION OF REFERENCE SIGNS

1: Sample temperature regulation device

2: Vial holder

4: Thermally conductive holder

4a: Recess

6: Non-thermally conductive holder

6a: Through hole

8: Housing hole

10: Vial

12: Peltier element (Cooling element)

14: Heat transfer plate (Heat transfer member)

16: Heat radiation fin

18: Sample rack

20: Heat insulation sheet

1. A vial holder for cooling temperature regulation,
wherein the vial holder has a plurality of accommodation holes having openings at their tops respectively so that vials containing a liquid are inserted into the accommodation holes respectively from their bottoms via the openings, and mounted on a heat transfer surface of a sample temperature regulation device,
the vial holder comprising:
a thermally conductive holder constituting a lower part of the vial holder and made of thermally conductive material, and being for causing heat exchange between bottom surfaces of the vials accommodated in the accommodation holes and the heat transfer surface by supporting at least the bottom surfaces; and
a non-thermally conductive holder constituting an upper part of the vial holder and made of non-thermally conductive material and being arranged so as to cover an upper surface of the thermally conductive holder while being in contact with the upper surface, and the non-thermally conductive holder including a plurality of through holes constituting at least a part of the accommodation holes respectively.

2. The vial holder according to claim 1, wherein a side surface of the thermally conductive holder is covered with a heat insulation sheet.

3. A sample temperature regulation device, comprising:
a heat transfer member for mounting the vial holder according to claim 1 thereon, the heat transfer member having a hear transfer surface for transferring heat to the thermally conductive holder of the vial holder by being in contact with the thermally conductive holder; and
a cooling element that cools the heat transfer member.
